(19) United States
(12) Patent Application Publication
(10) Pub. No.: US 2014/0131999 A1
(43) Pub. Date: May 15, 2014

(54) CLAW QUICK DISCONNECT INTERCOM FITTING

(71) Applicant: AERAZUR S. A., Caudebec-Les-Elbeuf (FR)

(72) Inventors: Amine Sannadi, Rouen (FR); Nicolas Picco, Abondat (FR)

(73) Assignee: AERAZUR S. A., Caudebec-Les-Elbeuf (FR)

(21) Appl. No.: 13/938,261

(22) Filed: Jul. 10, 2013

Related U.S. Application Data
(60) Provisional application No. 61/669,693, filed on Jul. 10, 2012.

(51) Int. Cl. F16L 37/088

(52) U.S. Cl. CPC F16L 37/088
USPC 285/321

(57) ABSTRACT

Embodiments of the present invention relate generally to a claw quick disconnect intercom fitting. The intercom fitting has a locking fit that features two independent locking systems that are generally operable together, without tools and with one hand. A claw ring and a clutch ring are configured to be assembled together and to move together, although they separately activate a claw lock and a clutch lock.

### CROSS REFERENCE TO RELATED APPLICATIONS

This application claims the benefit of U.S. Provisional Application Ser. No. 61/669,693, filed Jul. 10, 2012, titled “Claw Quick Disconnect Intercom Fitting,” the entire contents of which are hereby incorporated by reference.

### FIELD OF THE INVENTION

Embodiments of the present invention relate generally to a claw quick disconnect intercom fitting. The intercom fitting has a locking fit that features two independent locking systems that are generally operable together, without tools and with one hand. A claw ring and a clutch ring are configured to be assembled together and to move together, although they separately activate a claw lock and a clutch lock.

### BACKGROUND

Tank-to-tank connections are often required in the aerospace field, as well as other fields. For example, a tank-to-tank connection is generally needed for fuel transfer without leaks, particularly for helicopter or aircraft fuel systems. Generally, the connection between two tanks (which may be flexible material tanks or any other type of tank) is currently provided by a system that requires two flexible chimneys, a rigid sleeve, and metal clamps that are secured via screwdriver.

More specifically, prior art FIG. 16 shows one example of a prior art connection. This figure shows a first flexible chimney 1 that is first bonded to a rigid sleeve 3 on a tank. During assembly, a second flexible chimney 2 is assembled on the first flexible chimney 1 (generally using a lubricating means) and then fixed inside the tank by metal clamps 4 via a screwdriver. The connection (fastening) between the two tanks lasts around 15 minutes. Use of a screwdriver for the metal clamps during the assembly risks damaging the tanks or the flexible chimneys due to the constant pressure from screwing and unscrewing the clamps. The assembly also depends on the operator competence during the assembly because of the screwing. During the lifetime of tanks, as the tanks are fixed by screwing, there can be a decrease of the clamping force. Additionally, after some time, due to rubber aging, the two flexible chimneys could begin to remain stuck together, which leads to a difficult disassembly and adds to maintenance issues. Accordingly, improvements to these fittings are desired and necessary.

### BRIEF SUMMARY

Embodiments of the invention related generally to a claw quick disconnect intercom fitting. The intercom fitting has a locking fit that features two independent locking systems that are generally operable together, without tools. In some embodiments, the fitting may be secured and disconnected with a single hand. A claw ring and a clutch ring are configured to be assembled together and to move together, although they separately activate a claw lock and a clutch lock.

### BRIEF DESCRIPTION OF THE DRAWINGS

FIG. 1 shows a perspective view of two tanks to be coupled via an intercom fitting.

FIG. 2A shows a back perspective view of one embodiment of an intercom fitting with chimneys for use in attaching the fitting to tanks

FIG. 2B shows a front perspective view of one embodiment of an intercom fitting with the chimneys removed.

FIGS. 2C and 2D shows movement of the outer ring as it is being moved translationally, then rotationally.

FIG. 3 shows a side perspective cross-sectional view of the fitting in a locked configuration.

FIG. 4 shows a side plan cross-sectional view of the fitting in a locked configuration.

FIGS. 5 and 6 show the fitting components in an unlocked configuration.

FIG. 7 shows a perspective view of one embodiment of a claw ring.

FIG. 8 shows a side plan view of one embodiment of a female pipe.

FIG. 9A shows a side plan view of one embodiment of a clutch ring.

FIG. 9B shows a perspective view of the clutch ring of FIG. 9A.

FIGS. 10-13 show a series of images illustrating the unlocking sequence for one embodiment of a fitting. FIGS. 10A-10E show various views of the fitting in a locked configuration. FIGS. 11A-11H show various views of the fitting as it is being unlocked translationally. FIG. 12A-12F show various views of the fitting as it is being unlocked rotationally. FIGS. 13A-13D show the fitting in an unlocked configuration.

FIGS. 14A and 14B show side views of a fitting that highlights certain locking features of the fitting.

FIG. 15 shows a side view of a fitting that highlights certain other locking features of the fitting.

### DETAILED DESCRIPTION

Embodiments of the invention described herein provide improved connections for tanks, and particularly for fuel tanks on-board aircraft and/or helicopters and other airborne vehicles. The connections described herein may also be useful with other vehicles that require secure connections between tanks for fuel transfer or other purposes.

The intercom fitting shown and described is used to perform tank-to-tank connection and fuel or air transfer with no leakage in helicopter and/or aircraft fuel systems. Between two flexible material tanks, the connection is generally ensured by rigid sleeves (formed by the pipes and rings as described below), with the pipes bonded to chimneys 14, which connect the system to the flexible material of the tank. The secure assembly of the two sleeves into each other as shown and described seals the connection. In order to guarantee no leakage, the intercom fitting must be sized properly, in relation to the internal pressure generated by the fuel transfer and crash effect. It should also meet ESD (electrostatic discharge) requirements. According to required standards, the intercom fitting must incorporate two separate locking devices, as a fail-safe measure, according to CS§29.607. Selected materials for the intercom fitting may be, for example, a lightweight metal or alloy (such as 2024 aluminum) or a high-performance thermoplastic polymer (such as Polyphthalamide (PPA) with ESD properties) for mass saving. These are non-limiting examples only. In order to ease the assembly and the maintenance, the two independent locking devices are preferably fastened together through easy movements, preferably via one hand, and without tooling requirements.

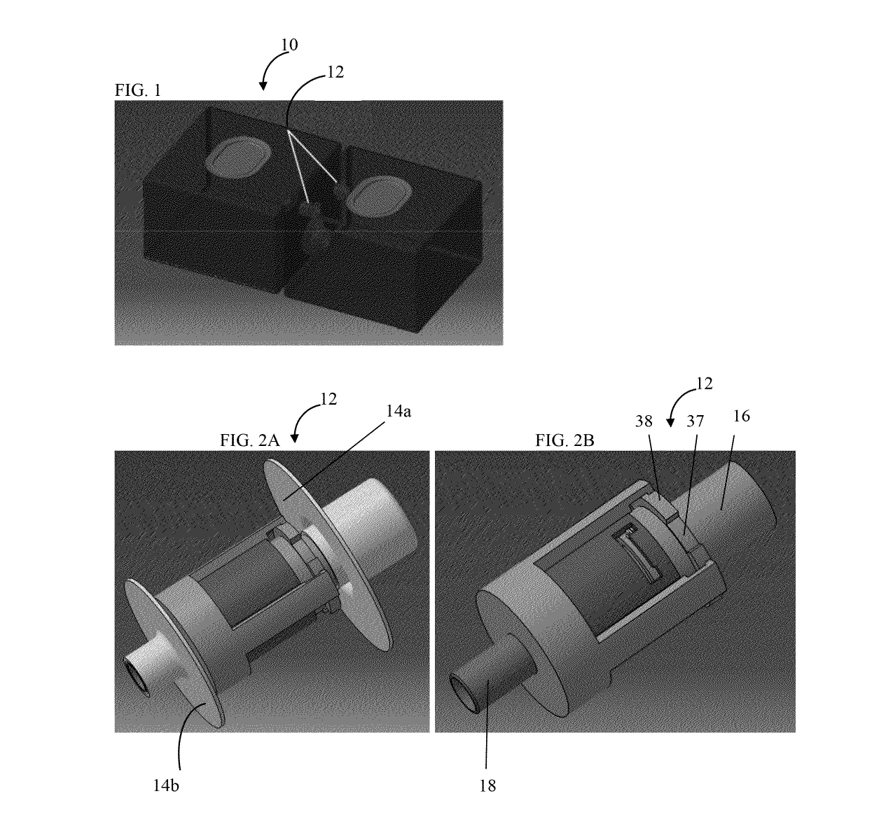

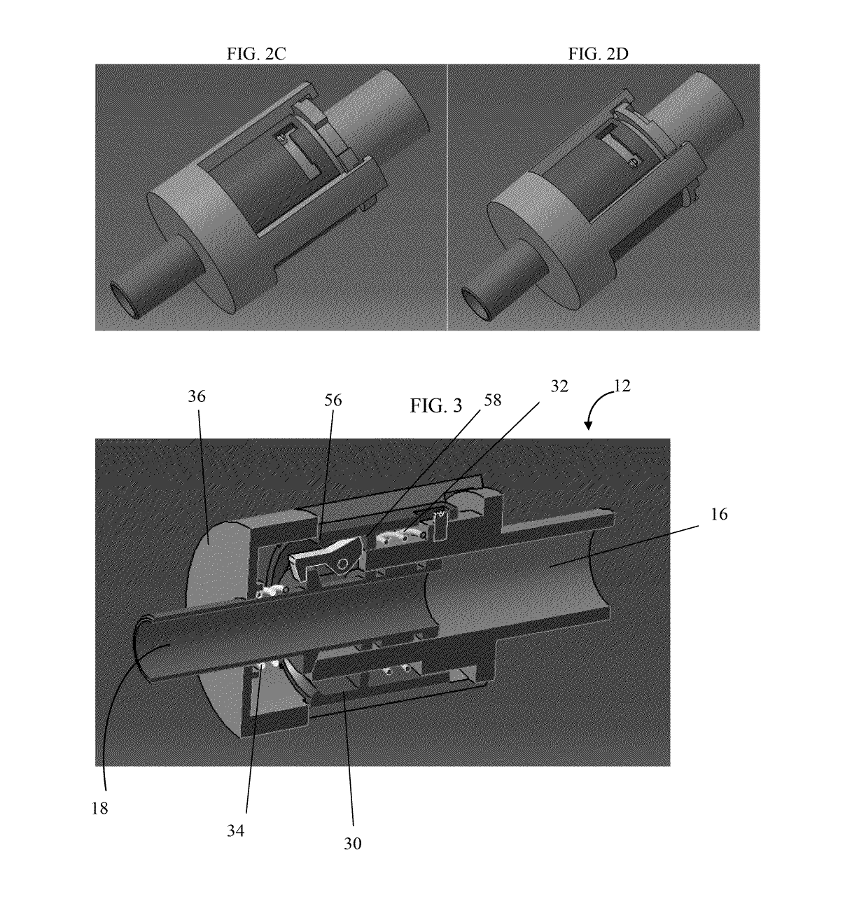

FIG. 1 illustrates two tanks 10 between which there is a secure fitting 12. A more detailed view of features of the fitting 12 is shown in the following figures. FIG. 2A illustrates two chimneys 14, each of which is secured to each tank 10 in use. Extending from one chimney 14a is a female pipe 16, and extending from the other chimney 14b is a male pipe 18. FIG. 2B illustrates the opposite side of the fitting 12 without the chimneys in place. This figure shows how an L-shaped groove in the outer ring allows that ring to rotate with respect to, and cooperate against, an inner ring. In FIGS. 2A and 2B, an inner and outer ring are in a locked position. FIGS. 2B-2D show the rings as they are being unlocked from one another. The transition between FIG. 2B and 2C shows movement of the outer ring as it pushed forward and translates against the inner ring. The transition between FIG. 2C and 2D shows the outer ring as it is being rotated with respect to the inner ring. FIG. 3 shows a cross sectional view of the locked configuration of FIG. 2A. As the inner/claw ring moves along its axis, it lifts and lowers claws, which represent a first locking system for the quick disconnect system. (Note that only one claw is represented in FIG. 3 due to the view shown, but multiple claws will generally be used.) The second locking system is provided by a locking clutch configuration between the outer/clutch ring and raised portions along the female pipe. A spring also helps lock the clutch system into place. These features will now be described in more detail below.

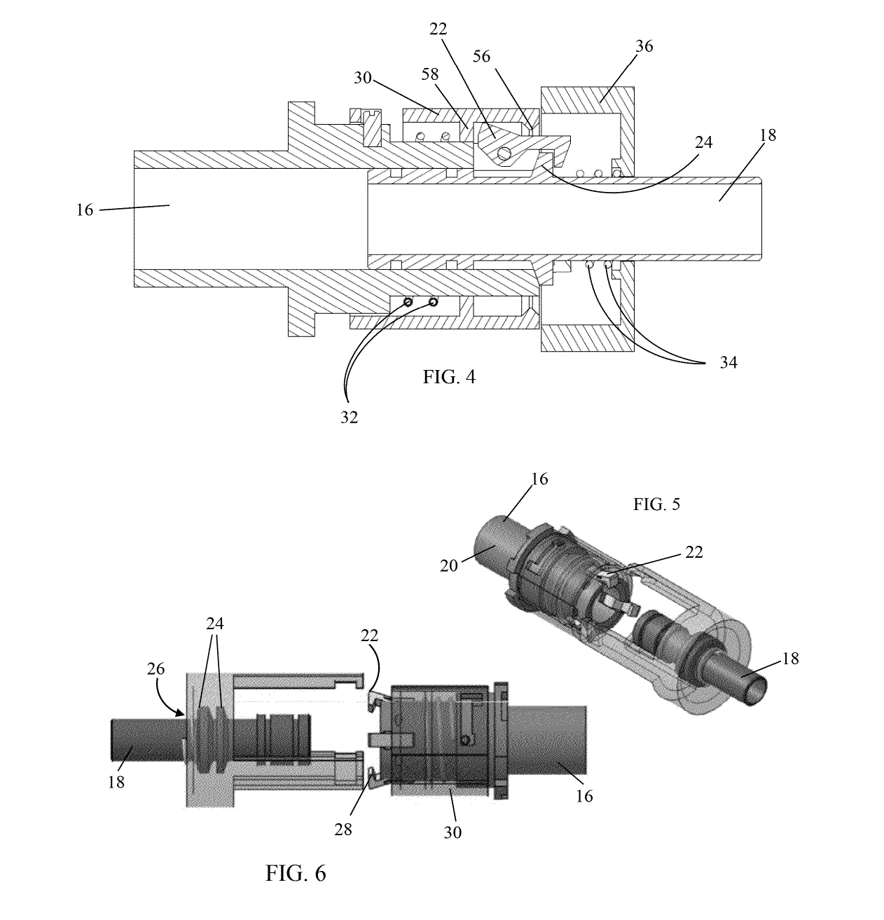

First, there are generally two pipes that cooperate with one another to create the connect. As shown in the cross-sectional views of FIG. 4-6, the female pipe 16 has a body portion 20 and one or more claws 22 at the distal end thereof. The claws may be secured to the pipe at a pivot point, attachment point, or any other securement area. The male pipe 18 has one or more indentations 24 at a claw connection area 26 on the male pipe 18. Cooperation between the one or more claws 22 and the indentations 24 create a first locking system. Although three claws are shown in the figures, it should be understood that more or fewer claws may be used, as long as they are capable of engaging with claw connection area 26. Claws 22 are also shown as having an angled head 28 but alternate shapes and configurations are possible and considered within the scope of the invention and claims.

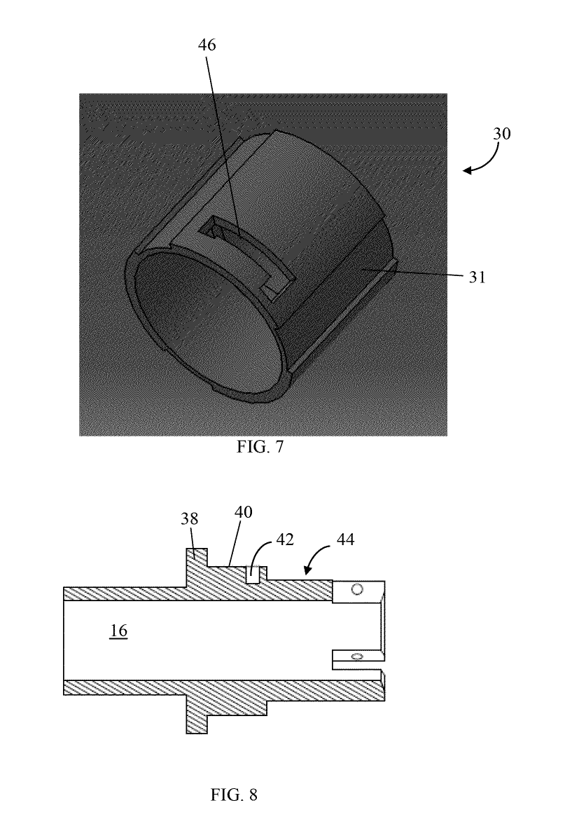

In order to activate and release claw(s) 22, a claw ring 30 is provided. In the figures shown, the claw ring 30 is provided as the inner ring, but it should be understood that it may be provided as the outer ring with only slight modifications. FIG. 7 shows a perspective view of claw ring 30. As shown, there is a guide slot 46 in the side of claw ring 30. When claw ring 30 is positioned over the female pipe 16, guide slot 46 is positioned so that it aligns with guiding pin recess 42 of the pipe 16, and a guiding pin 48 secures the claw ring 30 to the pipe 16 and helps to guide the rotational/twisting movement and the translational movement of the claw ring around the pipe 16 (and with respect to the outer/clutch ring, described in more detail below). Claw ring 30 also has one or more valleys 31, which provide a guiding groove for the arms of the clutch ring.

One end of the claw ring 30 also has a first claw cooperating portion, shown as a rounded head 56, extending into the interior of the ring 30, which applies pressure to the claws 22 when the claw ring 30 is pulled back and causes the claws 22 to lift. A few millimeters back on the interior of claw ring is a second claw cooperating portion, shown as a push arm 58. When the claw ring 30 is moved in the forward direction, the push arm 58 forces the claws 22 down into a locked position. The cooperation of these features is shown in FIGS. 3 and 4.

There are also two springs provided in the system, as illustrated by FIGS. 3 and 4. A first spring 32 is located at an interface between the claw ring 30 and the female pipe 16. A second spring 34 is located at an interface between the male pipe 18 and the clutch ring 36, which is described in more detail below. (In the embodiment shown, the clutch ring 36 is the outer ring, but it should be understood that it may be provided as the inner ring instead, with only slight modifications needed.) The presence of the first spring 32 allows the user to move the claw ring 30 with respect to the female pipe 16, which causes locking of the claws 22. The pressure of this spring 32 against the push arms 58 maintains the claw ring 30 in position and helps keep the claw(s) 22 in their locked position in the indentations 24 of the male pipe 16. The combined ring (both the claw ring 30 and the clutch ring 36) may be pushed forward, pulled back, and rotated/twisted, and activation of the spring 32 causes a transfer of force from the spring system to force the ring 30 forward. The claw(s) 22 engage the indentations 24 of male pipe 18, and lock the first locking system into place.

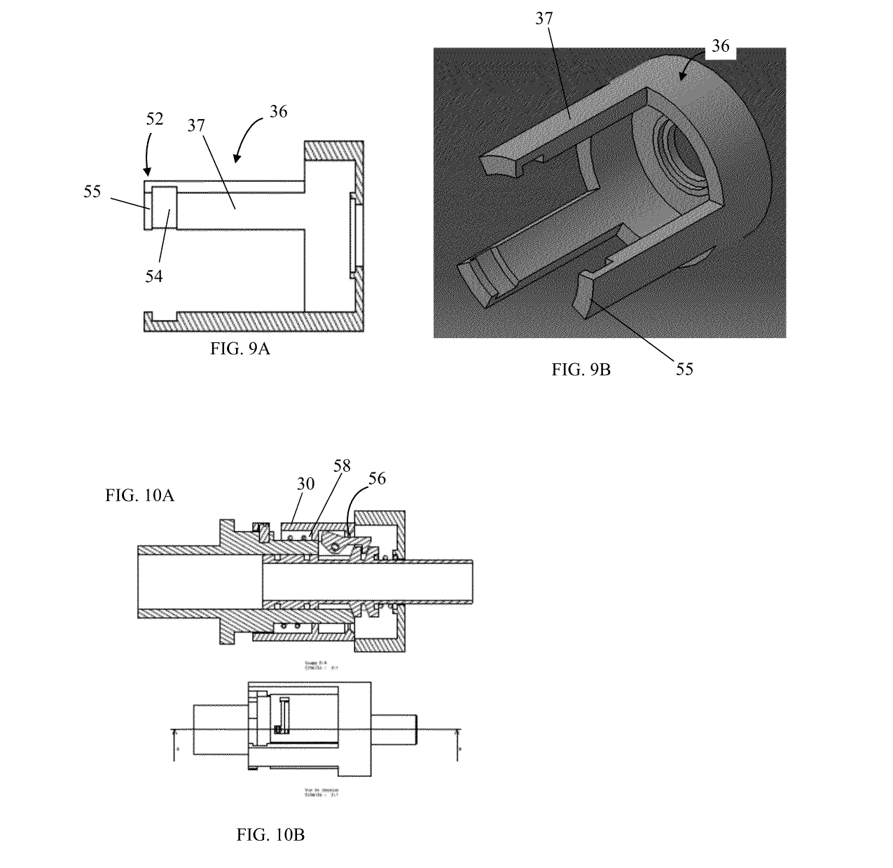

As described, however, intercom fitting 12 has two locking systems in order to meet required standards. Each locking system should be independently sufficient for locking on its own, in order to protect against failure of the other locking system. The second locking system embodiment provided is a clutch system. The clutch system generally includes clutch ring 36 (which is shown as the outer ring, but need not be), a spring 34, and features of the female pipe 16. A side sectional view of the female pipe 16 is shown in FIG. 8, and a side sectional view of the clutch ring 36 is shown in FIGS. 9A and 9B.

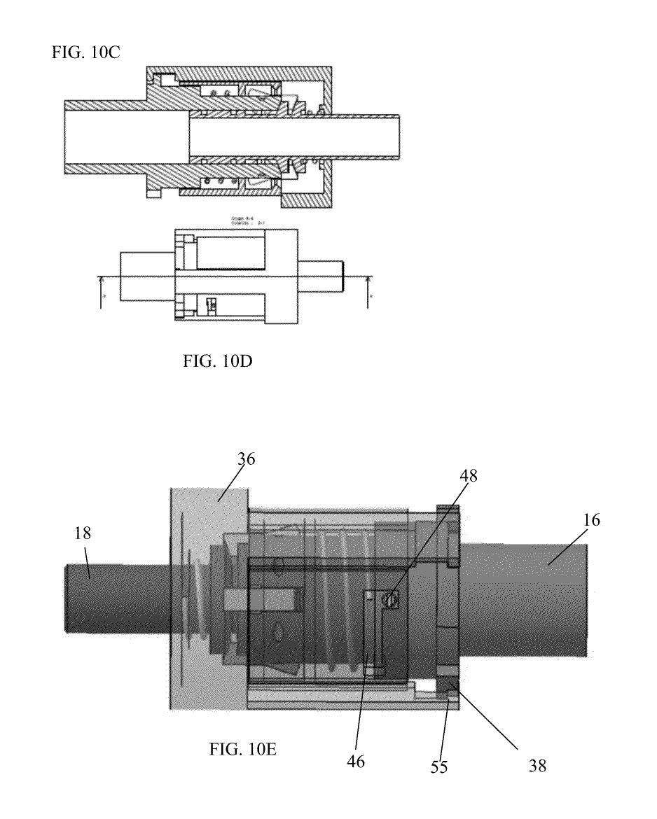

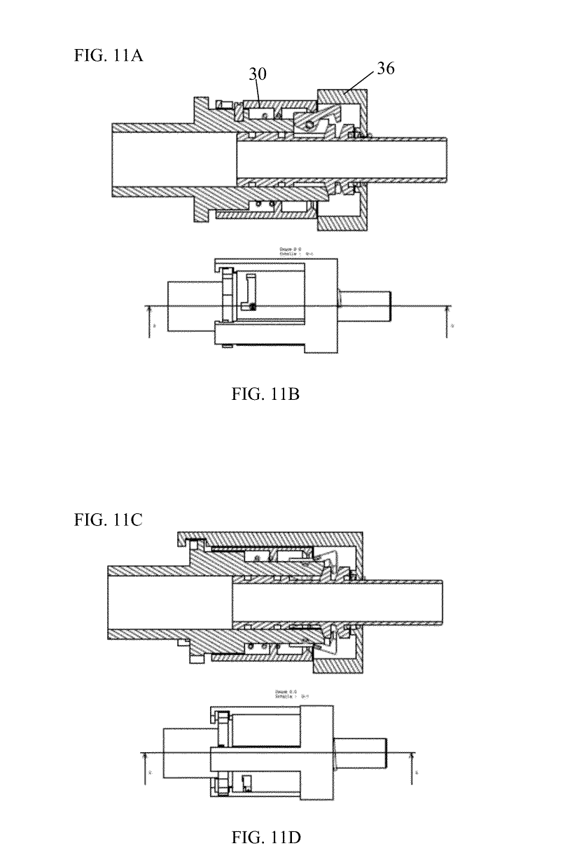

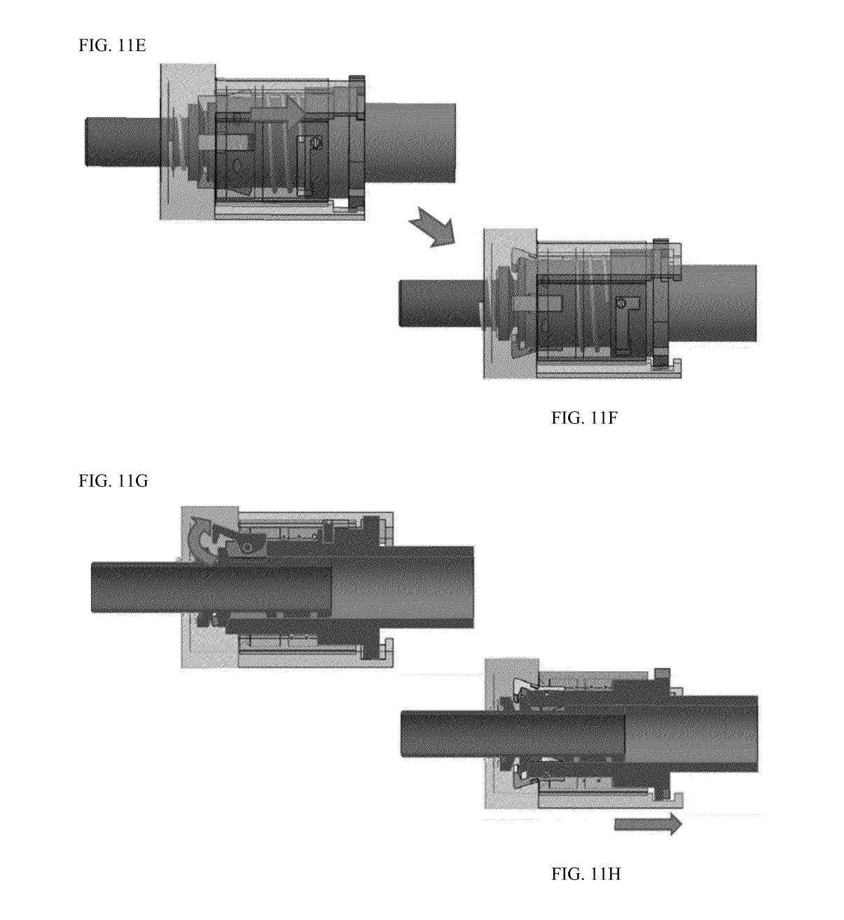

The female pipe 16 has a stepped configuration profile. The top of the step configuration forms a ring catch 38. As shown by the perspective view of FIGS. 2B-2D, the ring catch 38 also has lower areas 37, which create a castellated profile for the pipe and which provide sliding capabilities for the clutch ring for unlocking The middle step of the female pipe 16 forms a supporting area 40 for the claw ring (which can be seen more clearly by the locked position view, illustrated by FIG. 10A), and also has a guiding pin recess 42. The lower step 44 supports the rounded head 56 and push arm 58 of claw ring 30.

The clutch ring 36 has a cooperation end 52 with one or more indent portions 54 located at an end of each ring arm 37, creating a clutch grasp 55. The clutch grasp 55 provides a connection area where the clutch ring 36 can capture and secure against the ring catch 38 of the female pipe 16. In the locked configuration (as shown in FIG. 10E), clutch grasp 55 travels over the external surface valley 31 of the claw ring 30, and captures ring catch 38 in order to secure the clutch ring 36 into place. This occurs by pushing the clutch ring 36 up with respect to the claw ring 30 and causing the indent 54 of the arm 37 to extend over and rest on the ring catch 38. The second spring 34, which is located around the male pipe 18 end, generally where the pipe and the clutch ring 36 meet, helps maintain the clutch system in place. When the clutch ring is released in its locked position, the spring 34 pushes the clutch ring 36 forward to maintain its locked position.

In order to unlock the clutch ring 36, the clutch ring is pushed forward to release the clutch grasp 55, rotated slightly in order to cause the clutch grasp 55 to rest in one of the lowered portions 37 (of the ring catch 38) of the female pipe 16, such that the clutch grasp can slide down over the claw ring 30.

The rings are configured in any appropriate manner that allows the option of two independent locking systems that can be activated and engaged without the use of tools. The embodiment of rings that translate and rotate with respect to pipes has been shown to work particularly well, but it should be understood that other configurations are possible and within the scope of this invention. In the embodiment described, however, the inner ring/claw ring 30 is positioned over the female pipe 16 and secured in place via a guiding pin 48 extending through the guide slot 46 and into the guiding pin 46 slot. This allows the claw ring 30 to translate forward and back along the female pipe 16 axis, and the shape of the guide slot 46 also allows the claw ring to rotate around the female pipe 16 to the extent allowed by the slot 46. The slot 46 is shown as having a generally L-shaped configuration, but it should be understood that slot 46 may be any appropriate shape, such as C-shaped, J-shaped, T, shaped, or any other option.

The clutch ring 36 is positioned over the male pipe 18. In one embodiment, the clutch ring 36 is blocked during the bonding of the male pipe to the flexible chimney. As shown in FIGS. 5 and 6, the clutch ring 36 generally stays connected to the male pipe 16 and moves along with the male pipe. It is designed to allow access to the indentations 24 on the male pipe 16 so that the claw(s) can connect. However, other embodiments are possible.

FIGS. 10-13 show a series of images illustrating one embodiment of the system in a fastened to an unfastened sequence, also showing two different views of each step, a front view and a rear view. FIGS. 10A and 10B show the fastened system from one side view, and FIGS. 10C and 10C show a side view of the fastened system from the other side. FIG. 10E is a cut away view of the fastened system. FIGS. 11A-11F show the beginning of the unfastening. FIGS. 11A-B show a side view from one side of the fitting 12 to illustrate the first step of the unfastening movements. FIGS. 11C and 11D show a side view of the unfastening as it progresses further. More specifically, FIGS. 11A and 11B illustrate claws unfastening through a translational movement. FIGS. 11C and 11D illustrate the clutch unfastening. In this step, the outer ring/claw ring 36 is pulled back, which also pulls the inner ring/claw ring 30 back, allowing unfastening of the claws, as shown in the transition from FIG. 11E to FIG. 11F. This begins to allow unlocking of the claws and clutch, as shown in FIGS. 11G and 11H. In other words, movement of the claw ring unlocks the claws, and movement of the clutch ring unlocks the clutch. The movement of the two rings together simultaneously unlocks the fitting. This lends itself to connection and disconnection via a single hand, although in some embodiments, two hands may be used. The system does not, however, require the use of tools. Simply translating and rotating the rings via hand is all that is needed.

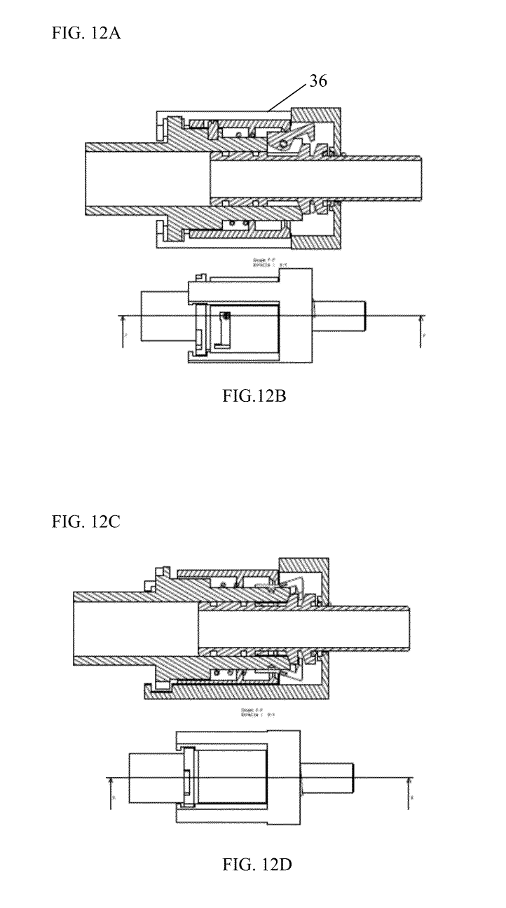

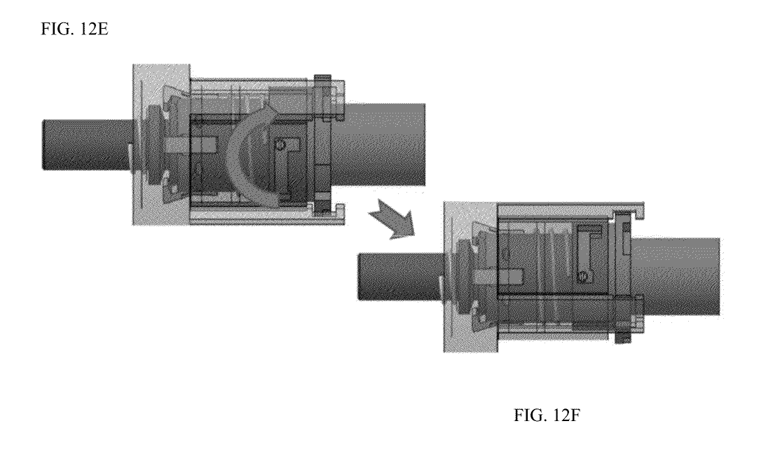

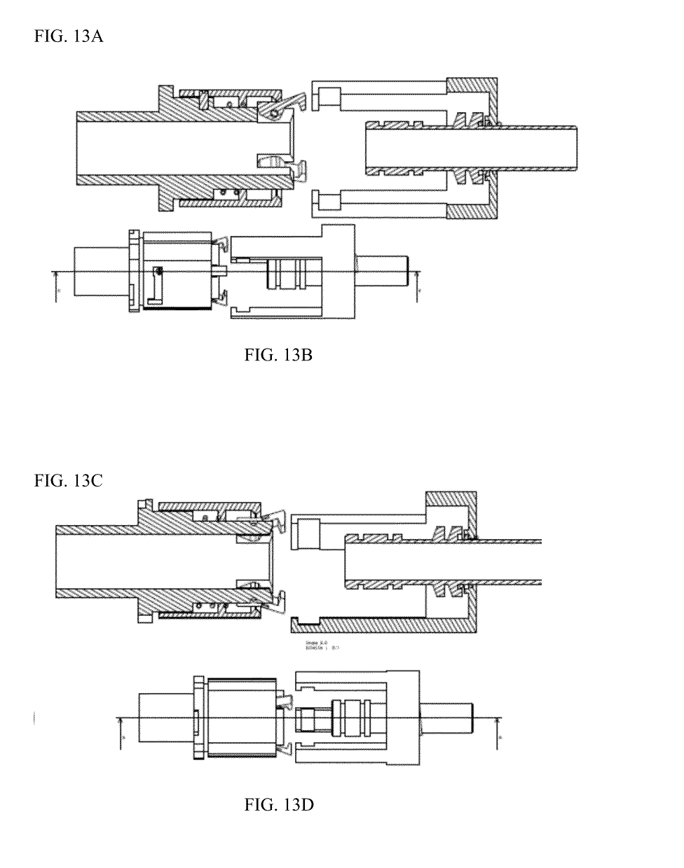

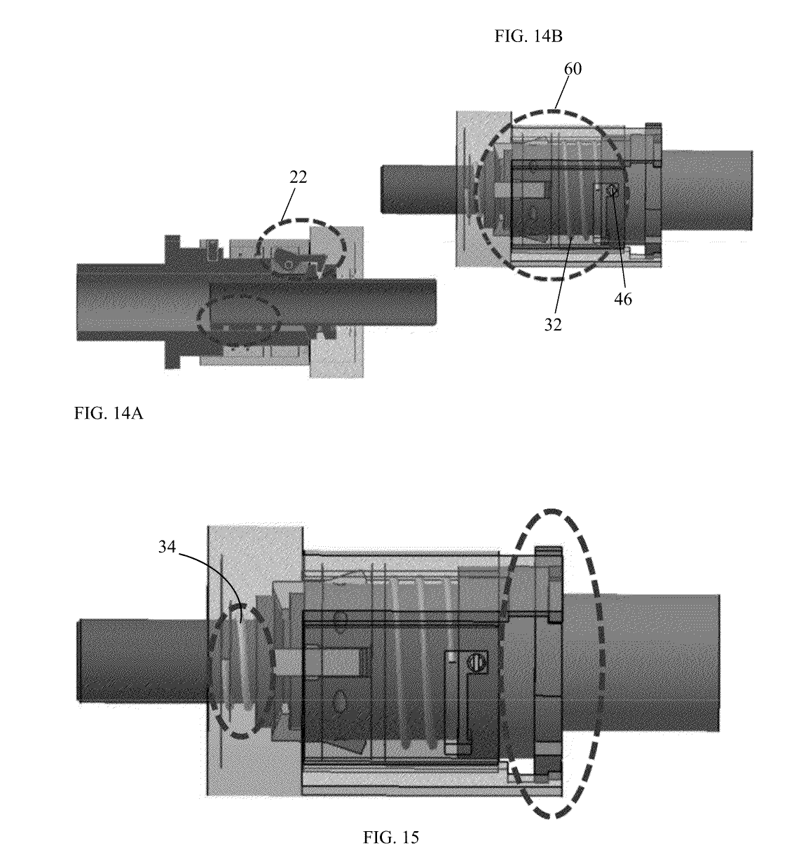

FIGS. 12A-12F show the second step of the unfastening, with the rotation/twisting of claw ring and clutch ring. During this step, the outer/clutch ring 36 is turned, which allows the clutch grasp 55 to unlock from the ring catch 38 and move into the lower areas 37. This movement also turns the inner/claw ring, which unlocks the claws 22. The male pipe 18 can then be pulled out of the female pipe 16, as shown in FIGS. 13A-D, and FIGS. 5 and 6, illustrating the unfastened system.

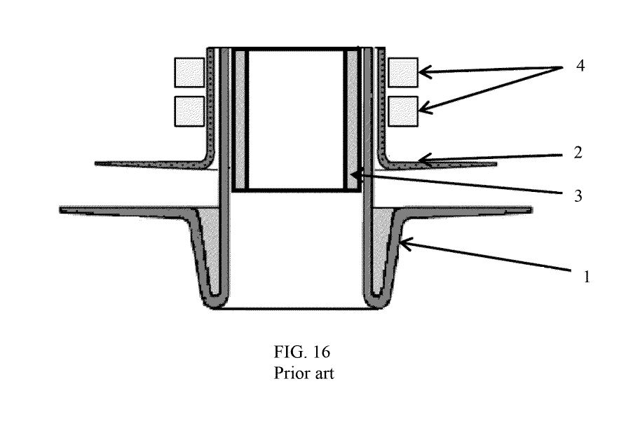

Advantages of the described features include but are not limited to providing two independent locking systems that are coupled in order to be easily fastened and unfastened. As shown in FIGS. 14A and 14B, the first locking system is created by a cylindrical fit 60 between the claw ring 30 and the clutch ring 36 (FIG. 14B), along with claws 22 that are kept closed by the inner/claw ring and its driving groove 46 and spring 32 (FIG. 14A). As shown in FIG. 15, the second locking system is created by clutch ring and the ring catch of the female pipe. A second spring 34 and its pressure against the outer/clutch ring 36 helps to push the ring 36 forward, and create cooperation between the clutch grasp 55 and the ring catch 38 in use. If the claw ring 30 breaks or becomes ineffective, the spring 34 will hold the clutch lock in place, creating two independent locking systems as required.

The system can be operated by a single one-hand manipulation. The two independent locking systems are also fastened and unfastened without the need for any tools. The embodiments described herein reduces the assembly timing to below about two minutes. Importantly, the mechanical resistance of the locking systems is independent from the operator manipulation. It does not depend upon the user operating or securing clamps via a screwdriver. The assembly integrates a system that minimizes user error in order to improve the safety of the system. The system ensures the lock and unlock of the system. It is also a benefit that the two independent locking systems are not identical in order to warranty the safety of the lock. If one of the locking systems fails, the other is present as a complete back-up. Each locking system is designed to work on its own, regardless of the effectiveness of the other lock, ensuring that a fault of one locking system will not lead to a leak. Each independent locking system is dimensioned in order to separately meet crash resistance requirements.

The first locking device is made by an integrated claw system, which works via a rotation axis for each claw, such that each claw can raise and lower in to a claw connection area. The second locking system is made by an integrated clutch and spring system.

The electrostatic discharge (ESD) property is integrated into the system through the choice of materials and design. The materials used for this application can be a mix of lightweight metal or alloy (such as 2024 aluminum) or high-performance thermoplastics (such as PPA or PEEK) or reinforced composites. The system described could be used for tank-to-tank, tank-to-tube or tube-to-tube connection.

Changes and modifications, additions and deletions may be made to the structures and methods recited above and shown in the drawings without departing from the scope or spirit of the invention and the following claims.

What is claimed is:

1. A quick disconnect intercom fitting for connecting two tanks, comprising:
a. first and second pipes, each configured to cooperate with one of the two tanks, one of the first or second pipes comprising a claw connect area and the other of the first or second pipes comprising (i) one or more claws and (ii) a ring catch;
b. a claw ring configured to cooperate with the pipe comprising one or more claws, the claw ring comprising an interior having (i) a first claw cooperating portion and (ii) a second claw cooperating portion, wherein translational and rotational movement of the claw ring with respect to the pipe comprising one or more claws causes the one or more claws to either be released or become locked into the claw connect area of the other pipe; and
c. a clutch ring configured to be positioned over the claw ring in use, wherein the clutch ring comprises a clutch grasp configured to cooperate with the ring catch, wherein translational and rotational movement of the clutch ring with respect to the pipe comprising the ring catch causes the clutch grasp and the ring catch to lock the first and second pipes together.

2. A quick disconnect intercom fitting for connecting two tanks, comprising:
a. first and second pipes, each configured to cooperate with one of the two tanks, one of the first or second pipes comprising a claw connect area and the other of the first or second pipes comprising one or more claws;
b. a claw ring configured to cooperate with the pipe comprising one or more claws, the claw ring comprising an interior having (i) a first claw cooperating portion and (ii) a second claw cooperating portion;
c. a clutch ring configured to be positioned over the claw ring in use, wherein the clutch ring comprises an alternate locking system,
d. wherein translational and rotational movement of the claw ring with respect to the pipe comprising one or more claws causes the one or more claws to either be released or become locked into the claw connect area of the other pipe.

3. The intercom fitting of claim 2, wherein in use, the claw ring translates along the pipe comprising one or more claws and the first claw cooperating portion causes the one or more claws to release and the second claw cooperating portion causes the one or more claws to engage the claw connect area of the other pipe.

4. The intercom fitting of claim 2, further comprising a spring positioned between the claw ring and the pipe comprising one or more claws.

5. The intercom fitting of claim 2, wherein the claw ring comprises an exterior with a guide slot that cooperates with a driving pin on the pipe comprising one or more claws, the guide slot having a dimension that allows the claw ring to be translated and rotated with respect to the pipe comprising one or more claws.

6. The intercom fitting of claim 2, wherein the alternate locking system of the clutch ring comprises a clutch grasp on the clutch ring and a ring catch on one of the first or second pipes, wherein the clutch grasp cooperates with the ring catch.

7. The intercom fitting of claim 2, wherein the alternate locking system of the clutch ring comprises the clutch ring being secured to the male pipe and having one or more arms with an indented area forming clutch grasp, and wherein the female pipe comprises a ring catch, such that in use, the indented area of the clutch ring rests against the ring catch to lock the clutch ring in place.

8. The intercom fitting of claim 2, wherein the clutch ring is positioned over the claw ring such that movement of the rings may be accomplished with one hand.

9. The intercom fitting of claim 8, wherein the claw ring comprises a valley configured to allow the clutch grasp to translate within.

10. A quick disconnect intercom fitting for connecting two tanks, comprising:
a. first and second pipes, each configured to cooperate with one of the two tanks, one of the first or second pipes a clutch ring and the other of the first or second pipes comprising a ring catch;
b. the clutch ring having a clutch grasp configured to cooperate with the ring catch, wherein translational and rotational movement of the clutch ring with respect to the pipe comprising the ring catch causes the clutch grasp and the ring catch to lock the first and second pipes together;
c. the clutch ring configured to be positioned over a claw ring in use, wherein the claw ring comprises an alternate locking system.

11. The intercom fitting of claim 10, wherein the pipe comprising the ring catch further comprises lowered areas in the ring catch, wherein in use, the clutch ring rotates to move the clutch grasp to the lowered areas so that the clutch ring can be pulled back to translate over the claw ring.

12. The intercom fitting of claim 10, wherein the clutch ring is secured to the male pipe and further comprising a spring positioned between the clutch ring and the male pipe.

13. The intercom fitting of claim 10, wherein the female pipe comprises one or more claws, wherein the male pipe comprises one or more claw connect areas, and wherein the alternate locking system of the claw ring comprises a claw ring configured to cooperate with the female pipe, the claw ring comprising an interior having (i) a first claw cooperating portion and (ii) a second claw cooperating portion, wherein translational and rotational movement of the claw ring with respect to the female pipe causes the one or more claws to either be released or become locked into the claw connect area of the male pipe.

14. The intercom fitting of claim 10, wherein the clutch ring is positioned over the claw ring such that movement of the rings may be accomplished with one hand.

15. The intercom fitting of claim 10, wherein the claw ring comprises a valley configured to allow the clutch grasp to translate within.
